(19) United States
(12) Patent Application Publication
(10) Pub. No.: US 2020/0102162 A1
(43) Pub. Date: Apr. 2, 2020

(54) STORAGE AREA FOR CONTAINERS AND METHOD FOR OPERATING A TRANSPORT VEHICLE IN A STORAGE AREA OF THIS TYPE

(71) Applicant: Konecranes Global Corporation, Hyvinkää (FI)

(72) Inventors: Armin Wieschemann, Oberhausen (DE); Stefan Aldejohann, Langenfeld (DE); Heiko Schulz, Leverkusen (DE); Jan Philipp Schmidt-Ewig, Essen (DE); Heinz-Christoph Eichner, Ratingen (DE)

(21) Appl. No.: 16/493,601

(22) PCT Filed: Mar. 15, 2018
(86) PCT No.: PCT/EP2018/056579

§ 371 Date: Sep. 12, 2019

(30) Foreign Application Priority Data
Mar. 15, 2017 (DE) 10 2017 105 561.4

(51) Int. Cl. B65G 63/00; B65G 65/00

(52) U.S. Cl. CPC B65G 63/004; B65G 2201/0235; B65G 65/005

(57) ABSTRACT

A storage area for containers having at least one storage region arranged between two travel paths for the gantry crane, such that the gantry crane can be moved over the storage region on the travel paths, and where a transfer region is arranged between the travel paths at an end of the storage region pointing in the travel direction of the gantry crane, which can be reached by the gantry crane and a transport vehicle to transfer containers into and out of the storage area. An intermediate region is provided between the transfer region and the storage region; the transfer region and the intermediate region are designed and arranged such that a passage through the transfer region and travel in the intermediate region is possible for a transport vehicle, and the travel in the intermediate region is possible before or after the passage through the transfer region.

### CROSS REFERENCE TO RELATED APPLICATION

The present application claims the priority benefits of International Patent Application No. PCT/EP2018/056579, filed Mar. 15, 2018, and claims benefit of German patent application DE 10 2017 105 561.4, filed on Mar. 15, 2017.

### BACKGROUND AND FIELD OF THE INVENTION

The invention relates to stores for containers and methods for operating a transport vehicle in such stores.

EP 2 637 954 B1 and DE 102 12 590 A1 disclose a store for containers which has at least one storage area and one gantry crane. The transfer areas of the store or their transfer lanes are designed as dead ends, for which reason boundaries can be provided at their long ends facing the storage area and the long sides and so, after a transport vehicle enters the transfer area and stops at this location for the purpose of transferring containers, a change in the wheel drive direction is required in order to then leave the transfer area or the transfer lane. Therefore, a change takes place between forwards travel and rearwards travel in order to travel into the transfer area and then travel out of the transfer area at the same point. If the transport vehicles used in this case are trailer trucks having an articulated trailer, this requires complex driving manoeuvres particularly during rearwards travel. Since these driving manoeuvres, which are described in greater detail hereinafter by reference to FIG. 3, take place outside the rail pair of the gantry crane associated with the respective storage area, the traffic at this location is adversely affected thereby.

A comparable container store is also known from DE 199 23 813 A1.

A container store including a gantry crane, of which the transfer area is arranged on a long side of the store, is known from European laid-open document EP 1 043 262 A1.

U.S. Pat. No. 5,769,589 discloses a container bridge which is movable on a quay via rails and which spans lanes for transport vehicles and a container ship located at the quay.

### SUMMARY OF THE INVENTION

The present invention provides improved stores for containers and an improved method for operating a transport vehicle for containers in such stores.

In accordance with aspects of the invention, a store for containers which has at least one storage area and at least one gantry crane, wherein the storage area is arranged between two travel paths for the gantry crane such that the gantry crane can be moved over the storage area on the travel paths, and wherein a transfer area is arranged at an end of the storage area pointing in the travel direction of the gantry crane between the travel paths, said transfer area being able to be reached by the gantry crane and by a transport vehicle for containers in order to place containers into the store or to remove said containers therefrom, is improved by virtue of the fact that an intermediate area is provided between the transfer area and the storage area, the transfer area and the intermediate area are designed and arranged in such a manner that passage through the transfer area and travel in the intermediate area is possible for a transport vehicle and the travel in the intermediate area is possible before or after the passage through the transfer area.

As a result, the transport vehicle can navigate the transfer area by means of particularly simple driving manoeuvres and in particular with a constant wheel drive direction during forwards travel. The correspondingly simple navigation of the transfer area includes both approaching and travelling into the transfer area as well as departing or travelling out of the transfer area in order to then move away from the transfer area after a container has been transferred or received. Therefore, the transport vehicle always travels into or out of the transfer area via the intermediate area.

The driving manoeuvres, which are required in the prior art and are described below in conjunction with FIG. 3, outside of the area located between the travel paths can thus be avoided. If rearwards travel is required for leaving the transfer area or for positioning the transport vehicle within the transfer area without colliding with the stacked containers intermediately stored in the storage area, this is effected in a manner directed in a straight line and in the area between the travel paths of the gantry crane (see FIG. 10). This simplifies a use of automatically guided transport vehicles in handling plants including a store in accordance with the invention. Even when manually guided transport vehicles are used, the creation of a corresponding intermediate area can relieve the drivers from having to perform complex driving manoeuvres and can save time and therefore it is possible to achieve increased throughput because any possibly required manoeuvring of the transport vehicle is transferred to the intermediate area and therefore does not adversely affect the traffic outside the area between travel paths.

Therefore, in contrast to the cited prior art, the transport vehicle does not have to exit the transfer area at the same point but instead can exit the transfer area at a different point than when entering the transfer area. The different points for entering and exiting said transfer area do not overlap in this case and preferably, however, are not compulsorily arranged at opposite ends of the transfer area. In this case, the opposite ends can point e.g. in parallel with the longitudinal extension of the travel paths of the gantry crane. However, it is also feasible to enter and exit the transfer area at the same point if the intermediate area is configured in such a manner that, within the intermediate area, it is possible to perform a 180° turn, which is described in greater detail below, in forwards travel with a constant wheel drive direction.

Since the intermediate area in accordance with the invention is arranged between the transfer area and the storage area, the travel of the transport vehicle through the transfer area and in the intermediate area is effected at least partially in the direction of the storage area, in particular during travel in the intermediate area after passage through the transfer area, or in a manner directed away from the storage area, in particular during travel in the intermediate area prior to passage through the transfer area. The transport vehicle can travel in terms of crossing without colliding with the storage area or with any possible boundaries of the transfer area with a constant wheel drive direction forwards into the transfer area and further forwards through the transfer area, preferably in parallel with the longitudinal extension of the travel paths of the gantry crane. In other words, the transport vehicle can travel, coming out of the intermediate area, forwards into the transfer area or initially can travel forwards, coming out of the transfer area, completely into the intermediate area. For this purpose, each transfer area has at least one, but preferably a plurality of transfer locations. Each transfer location is defined such that of a transport vehicle stopping on the transfer location at least the loading surface of the container is located in the transfer area such that, in terms of a container transfer, the gantry crane can be used for placing a container down on the transfer surface and picking it up therefrom for removal from storage and for placement into storage respectively. Accordingly, the transfer area or its transfer location can be reached both by the gantry crane and the transport vehicle.

In order to define the transfer location(s), a stopping position or a stopping area can be defined for each transfer location e.g. by a roadway marking and/or a gate and/or a signal device, in particular traffic lights, at which the transport vehicle must stop to ensure that it is positioned correctly on the transfer location and thus in the transfer area for a container transfer. In this case, the transfer locations can also each be defined on or in a transfer lane which extends preferably with its longitudinal extension in the direction of the storage area, preferably in parallel with its longitudinal extension or with the longitudinal extension of the travel paths of the gantry crane between the travel paths of the gantry crane and adjoins or merges into the intermediate area. The transfer lanes can be specified by roadway markings or barriers.

In an advantageous manner, an entrance area is provided between the travel paths of the gantry crane, through which a transport vehicle can approach the intermediate area and in this case in particular also reach said intermediate area, and/or an exit area is provided between the travel paths of the gantry crane, through which a transport vehicle can move away from the intermediate area and in this case in particular also exit said intermediate area. Moreover, the transfer area is allocated to the entrance area or the exit area. In this case, the entrance area or exit area provided between the travel paths is located between the adjacent and mutually facing ends of the travel paths which are arranged accordingly on the same side in relation to the longitudinal extension thereof, i.e. for example on the quayside. Therefore, the entrance area is used by the transport vehicles generally to enter the area between the travel paths of a storage area and the exit area is used by the transport vehicles to leave the area between the travel paths of a storage area.

Therefore, either the entrance area located upstream of the intermediate area or the exit area located downstream of the intermediate area serves as the transfer area. Travel through the entrance area is effected preferably in the direction of the storage area. Travel through the exit area is effected preferably in a manner directed away from the storage area. This applies in particular if both an entrance area and an exit area are provided between the travel paths or their ends.

However, it is also feasible that only one entrance area or an exit area is provided between the travel paths or their ends. This can be the case e.g. if the storage area is the outermost storage area of a store in terms of a boundary storage area and its end forms, together with the transfer area and intermediate area arranged at this location, a corner area of the store. In this case, the transfer area can be approached by a transport vehicle by performing turning movements in the intermediate area, e.g. making a 90° turn. In this case, said transport vehicle enters the intermediate area between the transfer area and the storage area transversely to the longitudinal direction in relation to the intermediate area, by crossing at least the outer travel path of the gantry crane and travelling over the travel path and in particular over the rail at that location. The 90° turn is then followed between the two travel paths by the passage through the exit area and the transfer area at that location. Similarly, the entrance area can also conversely be between the travel paths and the 90° turn can follow after the passage through the transfer area at that location in order to pass through the exit area over the outer travel path and leave the intermediate area.

Furthermore, provision can be made in an advantageous manner that two transfer areas are provided, of which a first transfer area is allocated to the entrance area and a second transfer area is allocated to the exit area. Therefore, both the entrance area located upstream of the intermediate area and the exit area located downstream of the intermediate area serve as the transfer area. Travel into one of the transfer areas is thus effected via the intermediate area in exactly the same way as travel out of the other transfer area is effected. In this case, both the entrance area and the exit area are then preferably arranged between the travel paths or their ends (see FIGS. 8 to 10). This is particularly advantageous if, as described in greater detail below, the orientation of the container door is to be taken into consideration when placing said container into the store. Then, depending upon the orientation of the container door on the transport vehicle, one of the two transfer areas can be selected in order to turn the container door towards or away from the storage area before transferring the container to the gantry crane.

In an advantageous manner, provision is also made that the intermediate area is designed in such a manner that for a transport vehicle, travel with turning movements is possible in the intermediate area, in particular a 90° turn and preferably a 180° turn—also defined as a U-turn—along a U-shaped route. Travel with turning movements which is effected with a constant wheel drive direction can also include a plurality of portions with changing turning radii, wherein travel directed in a straight line is also possible between individual portions. Therefore, even if e.g. two 90° turns are performed in the same turning direction and between these turns there is a section of travel in a straight line (see e.g. FIGS. 11 and 12), this is considered to be a 180° turn in terms of a U-turn. A U-turn thus does not necessarily require turning in a semi-circle without interruption. The intermediate area thus serves as a type of manoeuvring area or turning area, in which corresponding travel with turning movements with a constant wheel drive direction can be effected with the aforementioned advantages before or after passage through the transfer area. For the travel with turning movements or the routes thereof, lanes can also be provided and marked, said lanes adjoining the entrance and exit area or the transfer lanes at that location. If the transport vehicle is designed e.g. as a trailer truck, corresponding dimensions are required because such a vehicle can have a turning radius of e.g. ca. 10 m or more. Also, corresponding travel with turning movements can begin even in the transfer area (see FIG. 10).

In accordance with the invention, a store for containers which has two adjacent storage areas and at least two gantry cranes, wherein the storage areas are arranged in each case between two travel paths for one of the gantry cranes such that the respective gantry crane can be moved over the respective storage area on the travel paths, and wherein in each case a transfer area is arranged at an end of the respective storage area pointing in the travel direction of the gantry crane between the travel paths, said transfer area being able to be reached by the respective gantry crane and by a transport vehicle for containers in order to place containers into the store or to remove said containers therefrom, is improved by virtue of the fact that an intermediate area is provided in each case between the transfer area and the storage area, the transfer area and the intermediate area are designed and arranged in such a manner that passage through the transfer area and travel in the intermediate area is possible for a transport vehicle and the travel in the intermediate area is possible before or after the passage through the transfer area. The advantages stated above for a store comprising a storage area are achieved accordingly in this case. Preferably, as described in greater detail below, two gantry cranes are allocated to each storage area such that a total of four gantry cranes are provided in two adjacent storage areas.

In an advantageous manner, an entrance area is provided in each case between the travel paths of the gantry cranes, through which a transport vehicle can approach the intermediate area and in this case in particular also reach said intermediate area, and/or an exit area is provided between the travel paths of the gantry crane, through which a transport vehicle can move away from the intermediate area and in this case in particular also exit said intermediate area, and the respective transfer area is allocated to the entrance area or the exit area. The advantages stated above for a store comprising a storage area are also achieved accordingly in this case. If one of the intermediate areas is located upstream of the transfer area and the other intermediate area is located downstream of the transfer area, it is possible in this case to approach the particular storage area which permits placement into storage with a desired orientation of the container door because the transfer to the gantry crane, if required, is effected after the travel in the intermediate area and turning performed at that location for achieving the desired orientation.

In an advantageous manner, provision can also be made that the intermediate areas are connected to one another such that they form a common intermediate area for the two adjacent storage areas. In this case, provision is preferably made that a transport vehicle can reach the common intermediate area through the entrance area allocated to the first intermediate area, and can leave the common intermediate area through the exit area allocated to the second intermediate area. This permits more extensive driving manoeuvres than in a single intermediate area. As a result, more transfer lanes including transfer locations can also be established and used in the two transfer areas, in particular if the transfer areas are each allocated only to the exit area or only to the entrance area. This becomes apparent e.g. with reference to FIG. 11 which is described in greater detail below. Without the adjacent intermediate areas being connected, it would not be possible to perform a 180° turn with a constant wheel drive direction between the single-lane entrance area and the immediately adjoining transfer location allocated to the exit area by reason of the large turning circle of the transport vehicle and so this transfer location or the corresponding transfer lane could not be allocated to the exit area without the intermediate areas being connected.

In particular, in respect of the common intermediate area provision is made that the common intermediate area extends in a crossing area over the mutually facing travel paths of the two gantry cranes. The common intermediate area thus coincides partially with a transport area of the gantry crane or intersects same.

In a structurally simple manner, provision is made that the entrance area has a single lane and the exit area has multiple lanes or the entrance area has multiple lanes and the exit area has a single lane or the entrance area and the exit area have multiple lanes. Depending upon whether the transfer area is allocated to the entrance area or the exit area, the transfer area likewise has one or a plurality of transfer locations which can be allocated to the lanes serving as the transfer lanes. Accordingly, the transfer area can then also have a single lane or multiple lanes. Single-lane or multiple-lane entrance, exit and transfer areas are explained in greater detail by reference to the figures described below. In particular, the multiple-lane variants have the advantage that at least one transport vehicle can wait in each lane before continuing to travel into the intermediate area or before continuing to travel into lanes arranged outside the area between the travel paths of the gantry crane, until corresponding onward travel is possible or permitted. In particular, the traffic outside the area between travel paths of the gantry crane is thereby impaired to a lesser extent.

Safe operation of the store is thus achieved by virtue of the fact that a system for traffic regulation is provided. This system can comprise sensors and/or means for restricting access, such as e.g. signal devices, traffic lights and/or gates, in order to regulate, as described in greater detail below by way of example by reference to FIGS. 9 to 13, the travel of transport vehicles into the entrance area, transfer area, intermediate area or crossing area and to coordinate the movements of said vehicles with the movements of the gantry crane in and above the intermediate area or in the crossing area in order to prevent collisions between transport vehicles and between transport vehicles and the gantry crane. For example, either a transport vehicle or the gantry crane can be allowed to pass through the crossing area. Accordingly, when the gantry crane is allowed to pass through the crossing area, the crossing area is blocked for the transport vehicle, and vice versa. Furthermore, a transport vehicle can be stopped from completely entering the intermediate area and in particular the area for travel with turning movements, while at that location the gantry crane is transporting a container above the intermediate area. The oncoming traffic—occurring in the crossing area—of transport vehicles coming out of both intermediate areas in opposite directions can also be regulated or avoided by means of the system in order to avoid collisions. Moreover, a lane can be specified in the crossing area for each of the opposed travel directions.

The capacity of the store can be increased by virtue of the fact that a buffer area is arranged between the travel paths such that the intermediate area is arranged between the buffer area and the storage area. The area not used for driving manoeuvres of the transport vehicles can thus be used as a buffer area for the intermediate storage of containers.

In a structurally simple manner, provision can be made that a platform is arranged above the intermediate area. The platform extends preferably between the transfer area and the storage area, in particular centrally between the travel paths because above this the gantry crane is moved in order to transport containers over the intermediate area. If a container falls, it will fall onto the platform and not into the intermediate area and so the transport vehicles can travel safely in the intermediate area, while at the same time the gantry crane moves containers above the intermediate area. The platform can also be used as a buffer area for the intermediate storage of containers.

In accordance with the invention, a method for operating at least one transport vehicle for containers in a store designed as previously described is improved by virtue of the fact that the transport vehicle travels through the transfer area and travels before or after this in an intermediate area which is arranged between the storage area and the transfer area. In this case, the transport vehicle travels in particular with a constant wheel drive direction and so the aforementioned advantages are achieved in a similar manner Such a method is feasible not only for the operation of transport vehicles in the previously described exemplified embodiments but also in the configurations of the exemplified embodiments of the store which are described hereinafter.

In an advantageous manner, provision is also made that the transport vehicle travels in the intermediate area with turning movements, in particular a 90 degree turn and preferably a 180 degree turn along a U-shaped route. Such travel with turning movements relates to particularly simple driving manoeuvres with a constant wheel drive direction which result in the aforementioned advantages. In an equally advantageous manner, provision can also be made that the transport vehicle travels in a common intermediate area of two adjacent storage areas with turning movements, in particular a 90 degree turn and preferably a 180 degree turn along a U-shaped route. In relation to the travel with turning movements, the variants already mentioned above are also possible in this case.

In an advantageous manner, provision can also be made that the transport vehicle crosses one of the travel paths of the gantry crane. In this sense, in the case of a corner area of the store as already described above, the outer travel path can be crossed in order to leave the intermediate area not through the transfer area or an exit area between the travel paths but instead by crossing the travel path. Travel paths can also be crossed during travel from a first intermediate area into an adjacent second intermediate area. In this case, the mutually facing inner travel paths of the two adjacent gantry cranes are crossed.

In order to avoid collisions and the outage time caused thereby in the operation of a store, provision can be made that the traffic is regulated in the store. This relates in particular to traffic in which a plurality of transport vehicles are moving in the store, as well as the traffic in which at least one transport vehicle and the gantry crane are moving in the store. For example, the travel of a transport vehicle into the entrance area, transfer area, intermediate area and the crossing area and movements of the gantry crane above the intermediate area and above the platform possibly provided at that location, and into the crossing area are regulated and coordinated in this regard as already described above by reference to a system suitable for this purpose.

According to one advantageous use of a store or method in accordance with the invention, the transport vehicle is designed as a trailer truck. The trailer truck formed by a towing vehicle having a trailer coupled thereto in an articulated manner can have e.g. a turning circle of 10 m or more and so the intermediate area is to be dimensioned accordingly in order to permit travel with turning movements at least with a 90° turn without colliding with the storage area.

Some exemplified embodiments of the invention are explained in greater detail with reference to the following description.

### BRIEF DESCRIPTION OF THE DRAWINGS

FIG. 1 shows a schematic plan view of a handling plant for containers;

FIG. 2 shows a schematic side view of a transport vehicle for containers that is used in the handling plant of FIG. 1;

FIG. 3 shows a schematic plan view of a part of the first handling area of a conventional store with conventional transfer areas in a handling plant according to FIG. 1; and

FIGS. 4 to 13 each show schematic plan views of a store in accordance with the invention in the handling plant of FIG. 1 with associated transfer areas and methods in accordance with the invention according to different exemplified embodiments.

### DESCRIPTION OF THE PREFERRED EMBODIMENTS

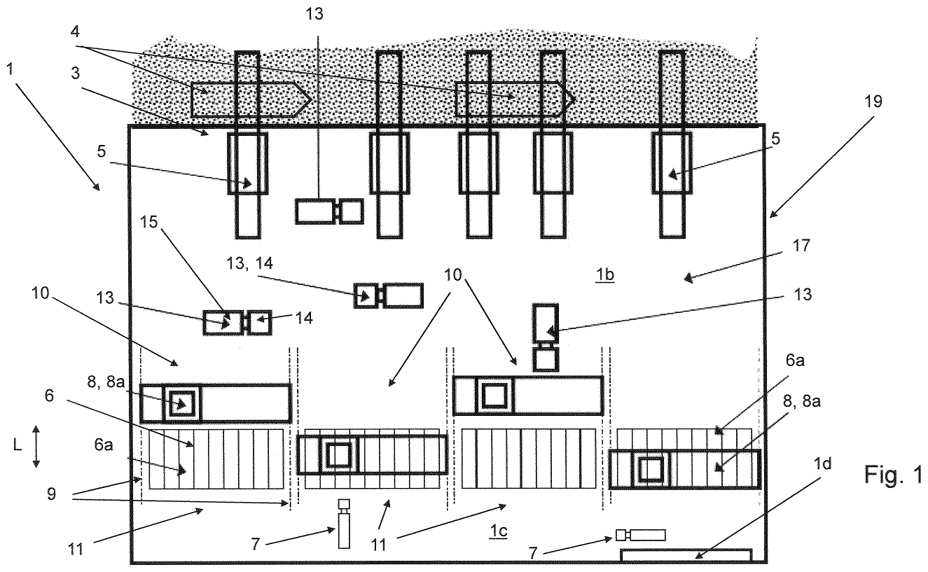

FIG. 1 shows a schematic plan view of a handling plant 1 for containers 2 in a port. In this case, ships 4 can dock at a quay 3 of the port in order to deliver or collect containers 2. In order to load or unload the ships 4, the quay 3 is provided with container bridges 5 which are also defined as ship-to-shore cranes and of which the jibs extend, on the one hand, over the ships 4 and, on the other hand, above the quay 3. Alternatively, the loading or unloading of the ships 4 can also be performed using so-called wharf cranes, of which the jib is pivoted in this case over the corresponding ship 4 about a vertical axis. Both the container bridges 5 and the wharf cranes represent so-called handling devices.

The containers 2 can weigh up to 40 t in the loaded state and can have normed or at least standardized lengths of e.g. 10, 20, 40, 45, 53 or 60 foot. In this case, the containers 2 can be designed as ISO containers and can have normed corner fittings. The two last-named lengths have hitherto been used exclusively in North America as non-ISO-normed containers. In this regard, ISO containers are understood to be normed large-volume or sea-freight containers which are used in the international transportation of goods. However, the containers 2 can also be other normed or at least standardized load carriers, such as e.g. swap bodies, in particular swap containers or swap trailers. In general, containers 2 have a container door which is arranged on a long end or the short side of the container 2 at that location.

The handling plant 1 is designed as a terminal or port terminal and accordingly is surrounded by a boundary 1a which is in the form of e.g. a fence or wall and extends to the edge of the quay 3. As a result, the handling plant 1 is separated from the outside surrounding area and from public roads outside the terminal. The handling plant 1 includes, as an essential component, within the boundary 1a a store 6 in which containers 2 can be intermediately stored after they have been unloaded from the ships 4 and before they are loaded for further transport outside the handling plant 1 onto a road vehicle or rail vehicle or after they have been delivered by said vehicles and before they are loaded onto the ships 4. Moreover, the handling plant 1 has, within the boundary 1a, a waterside, first handling area 1b with handing devices arranged on the quay 3 and has a land-side, second handling area 1c separated therefrom by the store 6.

The store 6 has at least one but typically a plurality of storage areas 6a having a rectangular footprint. Containers 2 can be placed down for intermediate storage and in particular can be stacked in stacks in each storage area 6a or the stacking area thereof. The storage areas 6a arranged in rows extend with their respective longitudinal extension along or in parallel with a longitudinal direction L and in this case are oriented in parallel next to one another and are arranged spaced apart from one another by small aisles. The containers 2 can be stacked in the storage areas 6a, wherein the containers 2 are oriented with their longitudinal extension likewise in parallel with the longitudinal direction L or longitudinal extension of the respective storage area 6a. This produces an arrangement of the stacks in the form of rows and/or in a grid pattern within the store 6.

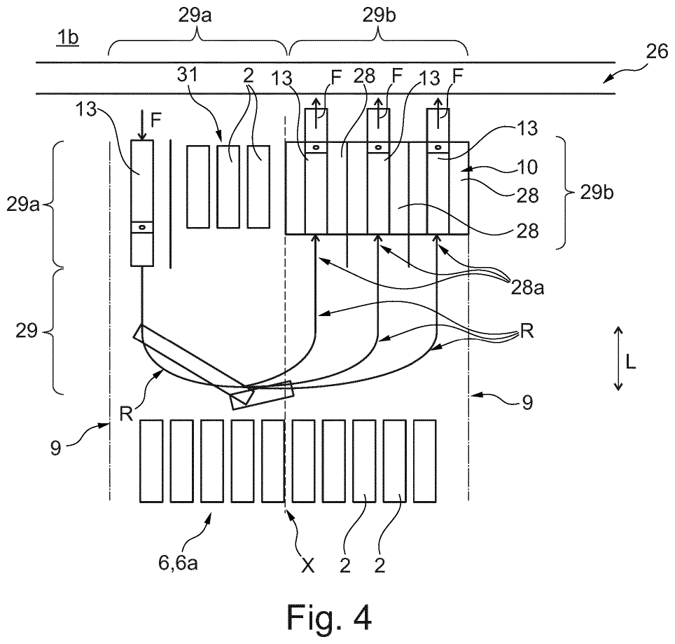

In order to manage the store 6, i.e. for placing the containers into the store 6 or its storage areas 6a and removing said containers therefrom, at least one stacking crane which is designed as a gantry crane 8 is allocated to each storage area 6a. Each gantry crane 8 can be moved over the respective storage area 6a. For this purpose, the corresponding gantry crane 8 spans, with its crane girder 8a extending horizontally and transversely, in particular at a right angle, to the longitudinal extension of the storage area 6a, the containers 2 stacked in the associated storage area 6a. In this case, the gantry cranes 8 are designed as automated stacking cranes, or ASCs for short. Such gantry cranes 8 can be moved by means of their running gear units on and along a pair of travel paths which extend preferably in or in parallel with the longitudinal direction L and between which the corresponding storage area 6a is located. The travel paths each include a rail 9 for the gantry crane 8 associated with the storage area 6a and define the travel direction of the gantry crane 8. The rails 9 are not elevated but instead are embedded e.g. in a ground surface 17 of the handling plant 1 and so the travel paths are located approximately at the height of the ground surface 17 in order to be able to be crossed by the transport vehicles, described hereinafter, at least in some exemplified embodiments of the invention. The aisles between the storage areas 6a can be dimensioned such that e.g. for maintenance and/or repair purposes, vehicles can pass between two storage areas 6a or between one storage area 6a and the boundary la and thus between the two handling areas 1b, 1c. The spacing between the travel paths or rails 9 can be 6 m in the aisles if passage of vehicles is to be possible, and otherwise the spacing is e.g. 3 m. The spacings in the aisles can alternate accordingly such that passage is possible in each second aisle. The travel paths or rails 9 of a storage area 6a are spaced e.g. approximately 32 m apart from one another if containers 2 can be placed down next to one another in ten rows (see FIGS. 4 to 12). However, these dimensions are only examples.

In order to transport containers 2 between the store 6 or its gantry cranes 8 and the handling devices arranged at the quay 3, internal transport vehicles 13 which are designed as heavy-load transport vehicles are used. The transport vehicles 13 are operated as special vehicles only internally in corresponding handling plants 1 and therefore are not designed or authorised for use on public roads. The waterside or quayside traffic of the internal transport vehicles 13 within the first handling area 1b is separated from the land-side traffic within the second handling area 1c by means of the store 6. The land-side traffic can consist of external transport vehicles 7 which are authorised for use on public roads and can travel into and out of the land-side, second handling area 1c only through a passing area 1d provided in the boundary 1a. The passing area 1d can have a security checkpoint for registering arrival and departure, including identification of the arriving and departing transport vehicles 7 and their drivers. The external transport vehicles 7 can be e.g. conventional lorries designed as trailer trucks. A connection to rail traffic is also possible in this manner in the handling area 1c.

In order to be able to remove containers 2 from storage or place said containers into storage, a first transfer area 10 for the internal transport vehicles 13 is arranged in the first handling area 1b at the quayside or waterside end, at that location, of each storage area 6a and a second transfer area 11 for the land-side traffic is arranged at its opposite land-side end. The transfer areas 10, 11 are thus not arranged on the sides of the storage area 6a which extend in parallel with the travel paths or rails 9, but instead are arranged on the sides or ends of the storage area 6a which point in the travel direction of the gantry crane 8 and extend transversely to the travel direction of the gantry crane 8 defined by the travel paths or rails 9. Said ends are typically long ends because, in contrast to the schematic view of FIG. 1, the storage areas 6a extend longer in parallel with the longitudinal direction L than transversely thereto. In this case, each transfer area 10, 11 is arranged between the travel paths or rails 9 of the gantry crane 8 associated with the respective storage area 6a in order to be able to be reached both by the transport vehicles 13 or the land-side traffic and by the gantry crane 8 for the purpose of placing containers 2 into storage or removing said containers therefrom. When a container 2 is being picked up or placed down which occurs during placement into storage or removal from storage, the gantry crane 8 spans, with its crane girder 8a, the corresponding transfer area 10 or 11 in which a transport vehicle 13 or a vehicle of the land-side traffic is situated for placing down or picking up a container 2. The transfer areas 10, 11 thus each constitute an interface between the store 6 and the landside or waterside traffic which in each case is also defined as horizontal traffic.

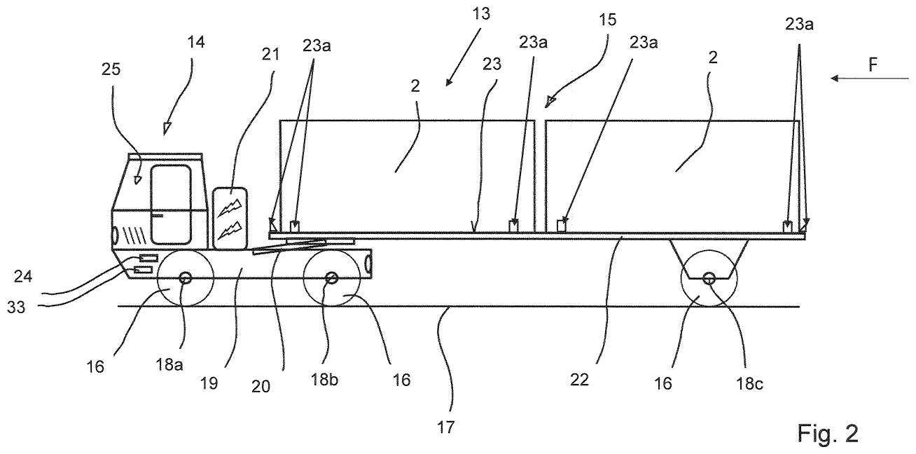

FIG. 2 shows a schematic side view of a transport vehicle 13 for containers 2 which is used in the handling plant 1 of FIG. 1. The transport vehicle 13 is designed by way of example as a trailer truck and accordingly comprises a towing vehicle 14 also defined as a terminal truck and a trailer in the form of a semi-trailer 15 which is coupled thereto in an articulated manner Such trailer trucks have a total truck weight of up to 200 t in the heavy-duty version. The towing vehicle 14, in its own right and without the semi-trailer 15, also constitutes a transport vehicle 13.

The transport vehicle 13 which is designed as a ground conveyor vehicle can travel freely on the ground surface 17, which is formed e.g. by the quay 3, by means of wheels 16 and can therefore travel in a floor-bound but not rail-bound manner Accordingly, the transport vehicle 13 is to be distinguished from rail vehicles. The wheels 16 are each provided with a tyre arrangement which is preferably an air-filled rubber tyre arrangement in the sense of tyres. Moreover, the transport vehicle 13 comprises a travel drive having at least one motor designed as an electric motor and a transmission in order to drive the wheels 16 thereby. The motor and the transmission are not illustrated for reasons of improved clarity. Instead of an electric motor, an internal combustion engine is basically also feasible. The wheels 16 are typically arranged on two axles 18a, 18b in the region of the towing vehicle 14. If the transport vehicle 13 is designed as a trailer truck, wheels 16 are also arranged on at least one further third axle 18c on the non-driven semi-trailer 15. Basically, it is also possible to provide other numbers of axles and axle arrangements with a corresponding number of wheels 16 if required from a technical point of view.

The transport vehicle 13 or its towing vehicle 14 comprises a chassis 19, on which the wheels 16 are mounted via the front first axle 18a and the rear second axle 18b. Moreover, a fifth wheel plate 20 which is part of a fifth wheel coupling is arranged in the rear region of the chassis 19. The fifth wheel plate 20 can be designed to be able to be lifted and lowered via a hydraulic drive and so the towing vehicle 14 can couple and uncouple the semi-trailer 15 actively and independently. The hydraulic lift of the fifth wheel plate 20 renders it possible to raise fifth wheel loads up to 45 t. A different way of coupling and uncoupling the semi-trailer 15 without a hydraulic lifting option is also feasible, e.g. by means of a coupling mechanism which can be manually actuated. The fifth wheel plate 20 can also be designed in an articulated manner such that the towing vehicle 14 and semi-trailer 15 are not routinely separated and therefore the towing vehicle 14 and semi-trailer 15 are permanently connected as a fixed unit in the form of a trailer truck. Moreover, the chassis 19 supports a battery 21 which powers the electric motor(s) of the travel drive of the transport vehicle 13 and is simultaneously moved therewith. The battery 21 is designed preferably as a rechargeable lithium-ion battery or as a lead battery and is arranged above the chassis 19 or below same e.g. between the two axles 18a, 18b in order to permit simple replacement with a charged battery 21. Alternatively, an additional battery 21 for powering the travel drive can also be arranged on the semi-trailer 15 and can be electrically connected to the travel drive for this purpose.

Furthermore, the transport vehicle 13 or its semi-trailer 15 has, on its frame 22, a substantially flat loading surface 23 for containers 2. In FIG. 2, two containers 2 which are designed as ISO containers and are about 20 foot in length are placed down one behind the other as seen in the travel direction F of forwards travel of the transport vehicle 13. The corner fittings of the containers 2 can be grasped e.g. by the load picking-up means—designed as a so-called spreader frame—of the gantry cranes 8 or container bridges 5 in order to raise the ISO container from the loading surface 23 or place it down on this surface.

In order to be able to guide a container 2 to be transported and in the case of ISO containers in particular its corner fittings as it is being placed down on the loading surface 23 and orientate it in relation to the loading surface 23, the loading surface 23 is delimited at its sides by a plurality of guide elements 23a. For this purpose, the guide elements 23a have guide surfaces which extend in an inclined manner. In this case, the guide surfaces extend in a manner directed upwards and outwards away from the loading surface 23 and extend in a manner directed downwards and inwards towards the loading surface 23. The guide elements 23a are preferably arranged in pairs on opposing sides, in particular long sides and/or short sides, of the loading surface 23. The guide surfaces of a pair of guide elements 23a form a type of funnel, the inclined extension of which tapers towards the loading surface 23 in order to achieve the guiding and orientating function. Accordingly, the guide surfaces of a pair of guide elements 23a widen in the upwards direction away from the loading surface 23.

The transport vehicle 13 is automatically guided in the sense of a so-called automated guided vehicle, or AGV for short, and for this purpose has a vehicle controller 24 which is schematically illustrated in FIG. 2. The driving manoeuvres of the transport vehicle 13 can be automatically controlled by means of the vehicle controller 24 in that transport orders planned e.g. via a management system are performed and travel routes which are specified in this respect are converted by control technology into corresponding driving manoeuvres. In this regard, steering procedures and speeds as well as accelerations of the transport vehicle 13 are automatically controlled by means of the vehicle controller 24 and the transport vehicle 13 thus navigates automatically. Furthermore, the transport vehicle 13 can be manually guided or controlled optionally by a driver also in the above-defined sense and so it is also feasible to alternate between manual and automatic guidance of the transport vehicle 13. For the manual variant, a driver's cab 25 including corresponding control means for manually engaging the vehicle controller 24 is arranged in the front region of the towing vehicle 14. In this case, an automatically guided transport vehicle 13 can also be manned if a driver also travels in said vehicle passively, but in this case not in the sense of having to or being able to actively engage the controller of the transport vehicle 13 as a vehicle driver. Transport vehicles 13 which are driverless but are manually remote-controlled by a vehicle driver are not deemed to be automatically guided vehicles but instead are deemed to be manually guided vehicles. In the case of exclusively automatically guided transport vehicles 13, the driver's cab 25 can remain driverless, as illustrated in FIG. 2, or can even be omitted. An exclusively manually guidable variant of the transport vehicles 13 is also possible.

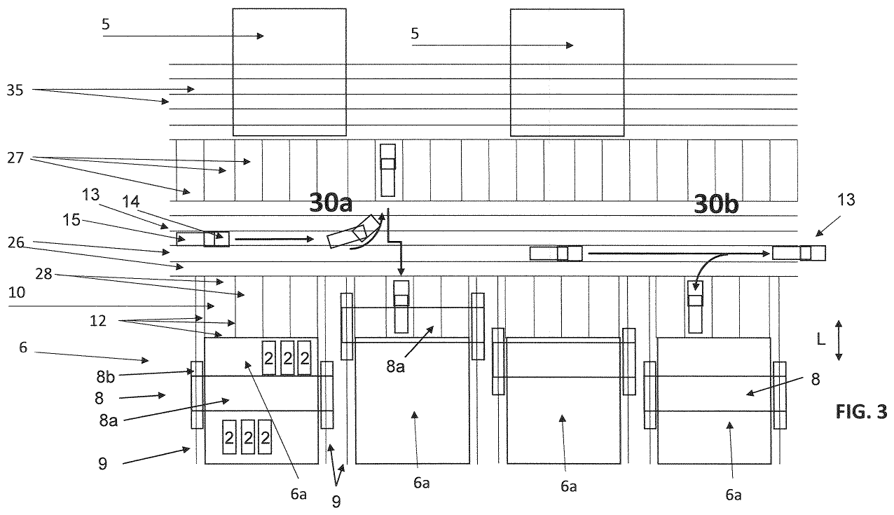

FIG. 3 illustrates a schematic plan view of a part of the first handling area 1b of a conventional store 6 with conventional transfer areas 10 in a handling plant according to FIG. 1. The total of four identical transfer areas 10 are arranged on the ends on the head-side and facing towards the quay 3 of the four storage areas 6a of FIG. 1 and can be reached by the transport vehicles 13 via lanes 26 running transversely, in particular at a right angle, to the longitudinal direction L. The lanes 26 are connected to transfer lanes 35 which are arranged at the quay 3 and lead to the handling devices, e.g. container bridges 5, at that location, in order to ensure that containers 2 can be transferred between the transport vehicles 13 and the handling devices at that location. Between the lanes 26 and the transfer lanes 35, the lanes 26 are adjoined by buffer lanes 27. The buffer lanes 27 are used by the transport vehicles 13 arriving via the lanes 26, as described hereinafter, for manoeuvring upon entering the transfer area 10, and are also used in this regard as waiting zones. The buffer lanes 27 extend transversely and preferably at a right angle to the lanes 26 and therefore in parallel with the longitudinal direction L.

Each transfer area 10 includes at least one transfer location but in the present case includes four transfer locations 28, the footprint of which is preferably rectangular in each case. The footprints of the transfer locations 28 extend with their longitudinal extension in the longitudinal direction L from the lanes 26 in the direction of the gantry crane 8 and the storage area 6a in the direction of the containers 2 stacked in the storage area 6a and so a transport vehicle 13 designed as a trailer truck fits completely onto a transfer location 28. Barriers 12 are provided between the respectively adjacent transfer locations 28 of each storage area 6a and at the store-side long ends such that the transport vehicles 13 can reach each transfer location 28 only from the adjoining lane 26 and can then leave said transfer location only on the same path or at the same point by effecting a change in the wheel drive direction.

In terms of placing a container 2 into storage or removing it from storage, two conventional methods for operating the transport vehicles 13 in the store 6 are typical. The driving manoeuvres to be performed in this case by the transport vehicles 13 are illustrated schematically in FIG. 3.

In the case of the first conventional method 30a, the transport vehicle 13 turns from the lane 26 initially travelling forwards, in a manner directed away from the transfer location 28 to be approached, making a 90° turn into a buffer lane 27, stops at this location and then manoeuvres with a wheel drive direction, which is opposite to the previous forwards travel, travelling rearwards onto the transfer location 28, wherein it is necessary to pass through all of the lanes 26. In this case, it may also be necessary to travel an approximately S-shaped route, e.g. if the buffer lane 27 opposite the transfer location 28 to be approached is occupied by a transport vehicle 13. The buffer lanes 27 thus serve as a waiting location if the transfer location 28 to be approached is occupied, or also serve as a manoeuvring surface for the transport vehicles 13 before entering the transfer area 10. After placing down or picking up a container 2, the transport vehicle 13 travels forwards down from the transfer location 28 and, associated therewith, out of the corresponding transfer area 10 and turns, whilst continuing to travel forwards, into one of the adjoining lanes 26.

In the case of the second conventional method 30b, the transport vehicle 13 travels in a lane 26 until it has passed the desired transfer location 26, stops and then manoeuvres travelling rearwards making a 90° turn onto the transfer location 28. In this case, it may also be necessary to pass through at least one lane 26.

In the case of both conventional methods 30a, 30b, the transport vehicles 13 thus manoeuvre in each case travelling rearwards onto the corresponding transfer location 28. The driving manoeuvres required in this regard are associated with a considerable amount of manoeuvring complexity for pinpoint rearwards travel onto the respective transfer locations 28. Also, lower speeds are possible in this case compared with forwards travel. This applies in particular if, as illustrated in FIG. 2, the transport vehicle 13 is designed as a trailer truck having a trailer fastened to the towing vehicle 14 in an articulated manner. In this case, lanes 26 are also blocked. All of this can be avoided in the case of the store 6 in accordance with the invention, as described hereinafter. As a result, in accordance with the invention a method is also provided for operating transport vehicles 13 for placing containers 2 into storage or removing said containers from storage with correspondingly simplified driving manoeuvres.

FIG. 4 shows a schematic plan view of a store 6 in accordance with the invention including an exemplary storage area 6a and its inventive, waterside, first transfer area 10. The following statements in relation to the transfer area 10 apply analogously also to the land-side transfer area 11 and the transport vehicles 7 at that location. The transfer area 10 includes at least one, but in the present case by way of example three, adjacent transfer locations 28 which are each allocated to a transfer lane 28a and onto which in each case a transport vehicle 13 can drive for the purpose of placing a container 2 into storage or removing a container 2 from storage or for placing down or picking up a container 2 and which for this purpose can also be reached in the above-described sense by the gantry crane 8 (not illustrated) or its load picking-up means. Accordingly, the travel paths or rails 9 of the gantry crane 8 are guided correspondingly far beyond the storage area 6a and so the transfer area 10 is arranged between the pair of travel paths in the area of the quayside ends thereof. Each transfer location 28 or the associated transfer lane 28a extends with its rectangular footprint analogously to the transfer locations 28 of FIG. 3 with its longitudinal extension in the direction of the containers 2 stacked in the storage area 6a, preferably in parallel with the longitudinal direction L. Moreover, each transfer location 28 is designed and arranged such that a transport vehicle 13 travelling forwards can drive onto the transfer location 28 and, after picking up or placing down a container 2, can leave the transfer location 28 likewise travelling forwards through the transfer area 10. Therefore, during forwards travel onto the transfer location 28 or into the transfer lane 28 and during forwards travel from the transfer location 28, the wheel drive direction of the transport vehicle 13 is the same. In this manner, the transport vehicles 13 can travel in the direction of the storage area 6a or the stacked containers 2 or in a manner directed away therefrom through the transfer area 10 and its transfer lanes 28a and in so doing can cross in particular the respective transfer location 28 with a constant wheel drive direction.

For this purpose, the transfer area 10 is adjoined by an intermediate area 29 which is arranged between the transfer area 10 and the storage area 6a or the containers 2 stacked therein. The intermediate area 29 is designed and arranged on the head-side at the illustrated end of the storage area 6a between the ends of the associated travel paths or rails 9 of the gantry crane 8 such that each transport vehicle 13 can travel in the intermediate area 29 before or after passing through the transfer area 10.

In this case, the intermediate area 29 can be reached, as illustrated in FIG. 4, between the waterside ends of the travel paths or rails 9 via an entrance area 29a and can be exited via an exit area 29b separated therefrom. The lanes both of the entrance area 29a and of the exit area 29b extend preferably in parallel with one another and in parallel with the longitudinal direction L which is in parallel with the longitudinal extension of the travel paths and thus also in parallel with the travel direction of the gantry crane 8. The entrance area 29a and the exit area 29b are arranged with respect to one another such that a change in direction with a constant wheel drive direction during forwards travel can be performed between the entrance area 29a and the exit area 29b in the intermediate area 29 by performing a 180° turn along a U-shaped route R in the manner of a so-called U-turn. In this case, the travel direction of the transport vehicle 13 itself remains the same, namely directed forwards, and the change in direction from approaching to moving away is performed merely in relation to the storage area 6a and relative thereto. In other words, the transport vehicle 13 does not travel further forwards towards the storage area 6a but instead travels forwards away from the storage area 6a. Travel in the intermediate area 29 is effected accordingly, at least before the change in direction, partially in the direction of the storage area 6a and is effected, after the change in direction, accordingly in the opposite direction.

FIG. 4 illustrates three U-shaped routes R by way of example. Each U-shaped route R adjoins the same single-lane entrance area 29a, but in each case leads to another one of a plurality of lanes of the exit area 29b, to which in each case a transfer location 28 of the transfer area 10 is allocated and so the lanes each serve as a transfer lane 28a. Accordingly, the U-shaped routes R can have different turning radii for the travel with turning movements as performed for the change in direction. In particular for manually guided transport vehicles 13 or the drivers thereof, lanes for the routes R can be specified e.g. by roadway markings or barriers.

In the view illustrated in FIG. 4, the single-lane entrance area 29a is located on the left in relation to a longitudinal axis X of the storage area 6a in parallel with the longitudinal direction L and the multiple-lane exit area 29b with the transfer area 10 is located on the right of the longitudinal axis X. Accordingly, the transport vehicles 13 travel through the intermediate area 29 and in this case the travel with turning movements for the purpose of the change in direction is performed in an anticlockwise direction with a left turn. By means of this arrangement, the U-shaped change in direction of the transport vehicles 13 is effected in each case before entering the transfer area 10 or its respective transfer lane 28a.

Arranged between the longitudinal axis X and the entrance area 29a is a buffer area 31 in which containers 2 can be placed down and stacked by the gantry crane 8 for intermediate storage. As a result, the space not used for the U-shaped 180° turns in particular by reason of turning radii of the transport vehicles 13 can be used as a space-saving storage surface and therefore the capacity of the store 6 can be increased.

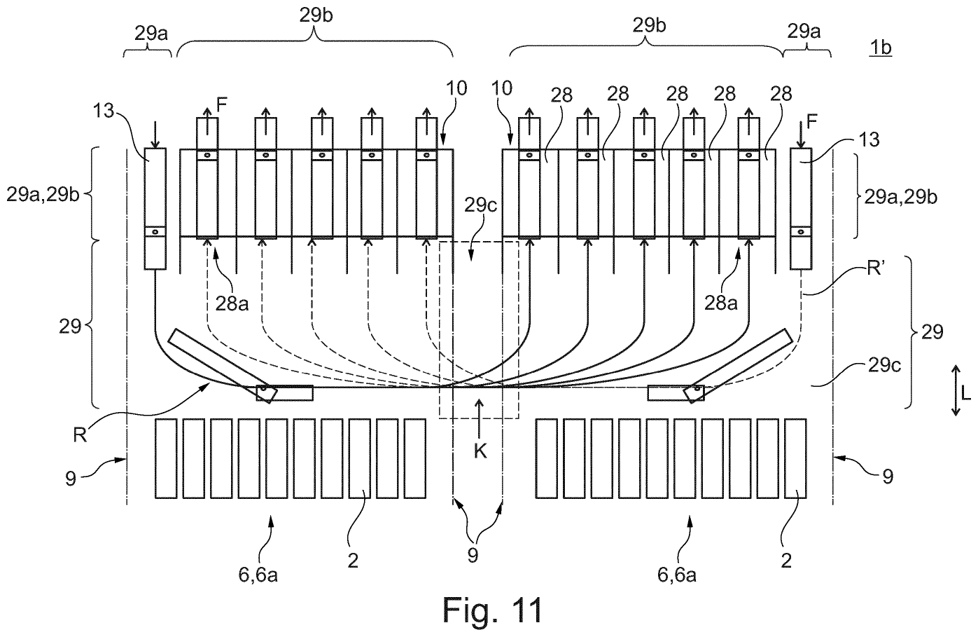

Basically, the buffer area 31 can also be omitted and instead the entrance area 29a can have multiple lanes in the left half or, as in the exemplified embodiment shown in FIG. 11, the left half can be used at least partially also as an exit area 29b with transfer locations 28 defined at that location.

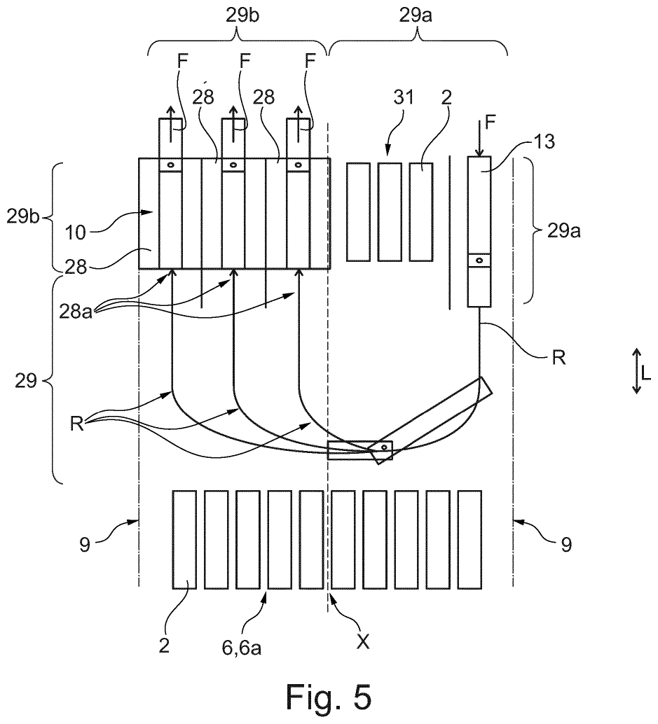

FIGS. 5 to 13 described hereinafter show examples of possible embodiments of the present invention in which the arrangement and design of the transfer areas 10 or transfer locations 28 and intermediate areas 29 also permit in each case comparable driving manoeuvres of the transport vehicles 13, in particular in order to pass through the transfer area 10 or its transfer locations 28 with a constant wheel drive direction and in particular travelling forwards after container transfer.

The exemplified embodiment illustrated in FIG. 5 differs from that of FIG. 4 substantially by reason of an arrangement—reflected in relation to the longitudinal axis X—of the entrance area 29a, of the exit area 29b with the transfer locations 28 or transfer lanes 28a arranged at that location, and of the buffer area 31. Accordingly, the transport vehicles 13 perform U-shaped turning movements for the change in direction in the intermediate area 29 in a clockwise direction with a right turn but, just as in FIG. 4, before entering the respective transfer location 28 and subsequently passing through the corresponding transfer area 10.

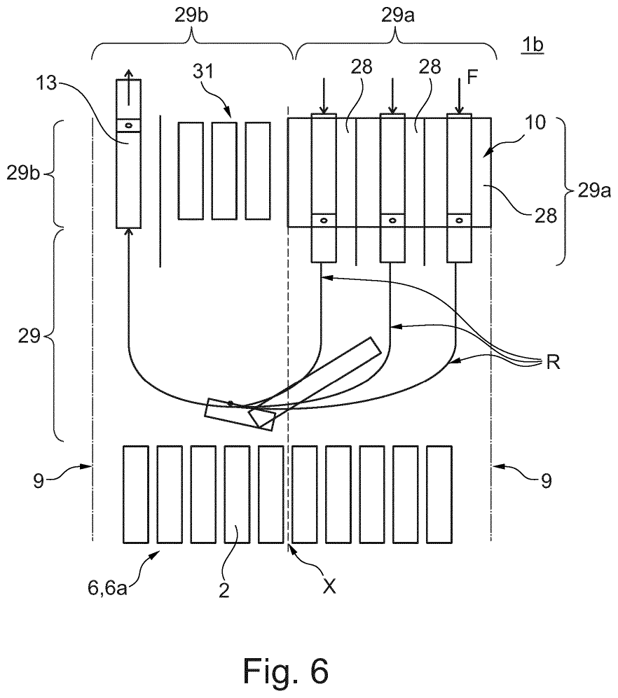

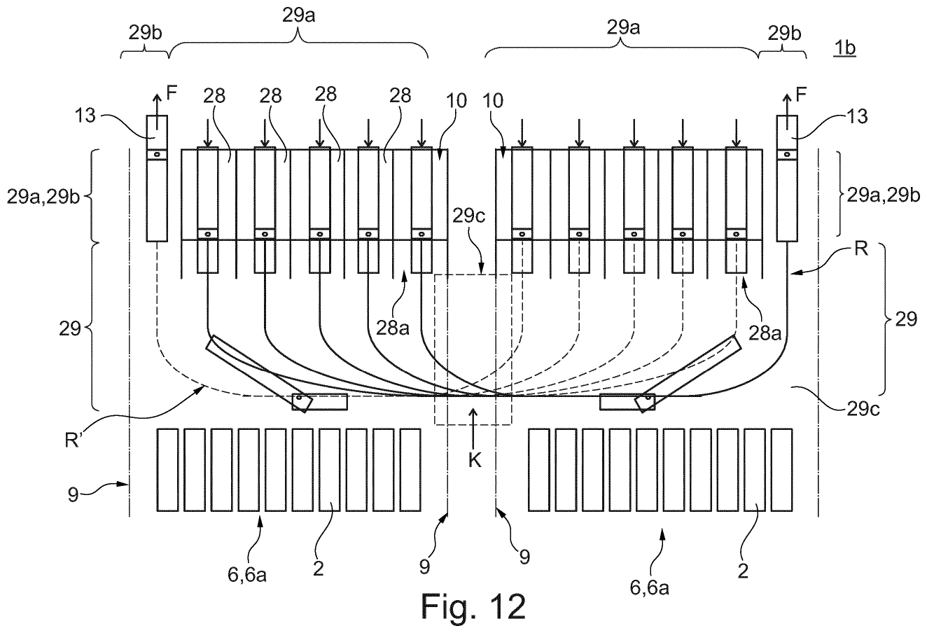

The exemplified embodiment illustrated in FIG. 6 differs from that of FIG. 4 in that the travel direction of the transport vehicles 13 through the intermediate area 29 and the transfer area 10 is opposite. Accordingly, the transfer locations 28 and transfer lanes 28a on the right of the longitudinal axis X are allocated to the entrance area 29a and so the travel with turning movements for the purpose of changing the direction of the transport vehicles 13 is effected in an anticlockwise direction as in FIG. 5. However, in contrast to FIGS. 4 and 5, travel into the corresponding transfer area 10 for container transfer is effected before the change in direction and the change in direction is thus effected only after leaving the transfer area 10 or the transfer location 28 and the subsequent passage through the transfer area 10. Therefore, unlike in FIGS. 4 and 5, the entrance area 29a shown in FIG. 6 also has multiple lanes and the exit area 29b has a single lane. Basically, the buffer area 31 can also be omitted in this case and instead the exit area 29b can have multiple lanes in the left half or, as in the exemplified embodiment shown in FIG. 12, the left half can be used at least partially also as an entrance area 29a with transfer locations 28 defined at that location.

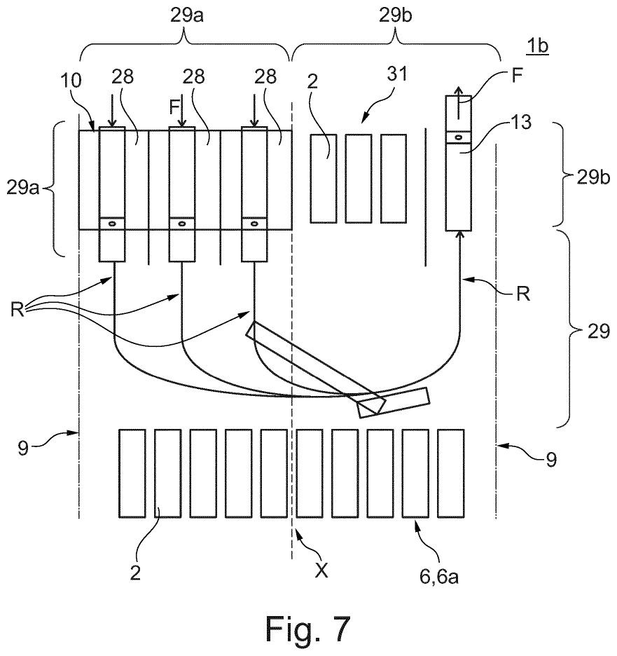

The exemplified embodiment illustrated in FIG. 7 differs from that of FIG. 6 substantially by reason of an arrangement—reflected in relation to the longitudinal axis X—of the entrance area 29a with the transfer locations 28 or transfer lanes 28a arranged at that location, of the exit area 29b and of the buffer area 31. Accordingly, the transport vehicles 13 perform U-shaped turning movements for the change in direction in FIG. 7 in an anticlockwise direction but, just as in FIG. 6, after entering the respective transfer location 28 and subsequently passing through the transfer area 10.

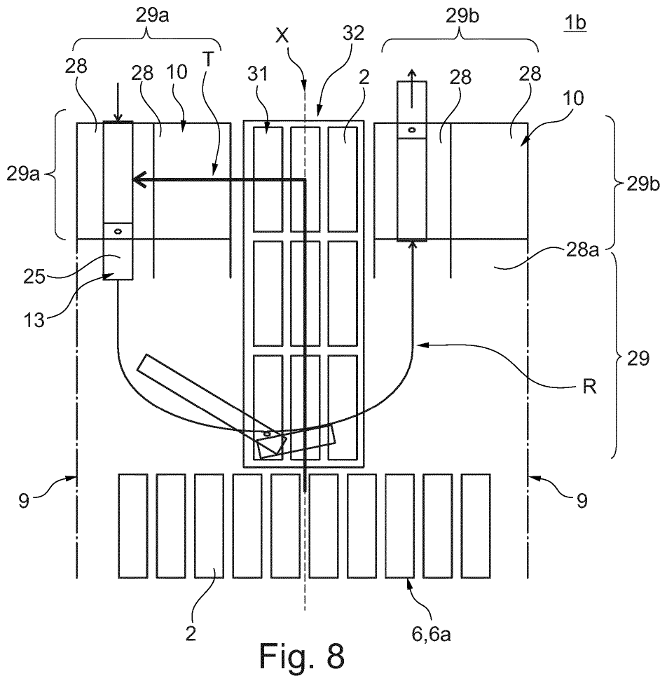

The exemplified embodiment illustrated in FIG. 8 differs from the previous ones in that a transfer area 10 including at least one, in the present case two, transfer locations 28 is each allocated to both the entrance area 29a and the exit area 29b. Therefore, the entrance area 29a, just like the exit area 29b, can have multiple lanes and can have corresponding lanes serving as transfer lanes 28a. Since transfer locations 28 and thus a total of two transfer areas 10 are defined both in the entrance area 29a and in the exit area 29b, the transport vehicles 13, before and after the change in direction, travel into and through one of the transfer areas 10 and onto the transfer locations 28 there. The travel with turning movements or the changes in direction provided in FIG. 8 are effected in an anticlockwise direction, but alternatively can also be effected in a clockwise direction together if the entrance area 29a and the exit area 29b are swapped and therefore are defined in a reflected manner in relation to the longitudinal axis X.

In contrast to the previous exemplified embodiments, the buffer area 31 is not arranged in the intermediate area 29 on the ground surface 17 but instead is arranged there above on a platform 32 which is spaced apart from the ground surface 17 in the vertical direction and which, for this purpose, can be elevated e.g. by means of supports, not illustrated. The preferably rectangular platform 32 spans a part of the intermediate area 29, in particular between the transfer areas 10 and between the transfer areas 10 and the storage area 6a. For this purpose, the platform 32 extends along the longitudinal axis X over the intermediate area 29 and also beyond this between the entrance area 29a and the exit area 29b. The platform 32 extends transversely to the longitudinal axis X in the direction of the entrance area 29a and the exit area 29b or the transfer areas 10 at that location. As a result, the platform 32 offers the safety function described hereinafter. The routes R for the U-shaped change in direction run underneath the platform 32 during the travel with turning movements in the intermediate area 29. Since the gantry crane 8 with a container 2 suspended from its load picking-up means is moved only in the direction of the storage area 6a or away therefrom, if the load picking-up means and the container 2 are arranged above the platform 32, in particular centrally above the longitudinal axis thereof, the platform 32 serves as protection for the transport vehicles 13 travelling underneath the platform 32 against possibly falling containers 2. The correspondingly possible transport routes T of containers 2 moved by means of the gantry crane 8 are likewise outlined in FIG. 8. Containers 2 suspended from the gantry crane 8 are moved according to the transport routes T above the intermediate area 29 along and in the region of the longitudinal axis X and only in the region of the transfer areas 10 transverse thereto.

In this regard, in the case of manually guided transport vehicles 13 it is also ensured for safety reasons that the driver's cab 25 of a transport vehicle 13 positioned correctly on the transfer location 28 is arranged outside the transfer area 10, whereas the loading surface 23 is arranged in the transfer area 10. Accordingly, the transfer location 28 in this case is longer than the transfer area 10 and is partially already in the intermediate area 29. For this purpose, the driver positions the transport vehicle 13 accordingly on the transfer location 28 and in the transfer area 10. Therefore, by means of the platform 32 the transport vehicles 13 can pass through the intermediate area 29 and the gantry crane 8 can transport a container 2 over the intermediate area 29 at the same time along the longitudinal axis X. This ensures that, as seen in the plan view of FIG. 8, the transport routes T and the routes R cross one another only in the region of the longitudinal axis X and of the travel with turning movements performed in the intermediate area 29 underneath the platform 32, where, however, the transport vehicles 13 travelling along the routes R are protected by the platform 32 against a possibly falling container 2. Otherwise, the transport routes T and the routes R do not cross one another in the intermediate area 29. Basically, in the other exemplified embodiments, the buffer area 31 can also be arranged on a corresponding platform 32 and the transport routes T can extend above the platform 32 and so the transport vehicles 13 are protected in the manner previously described in the area of the travel with turning movements.

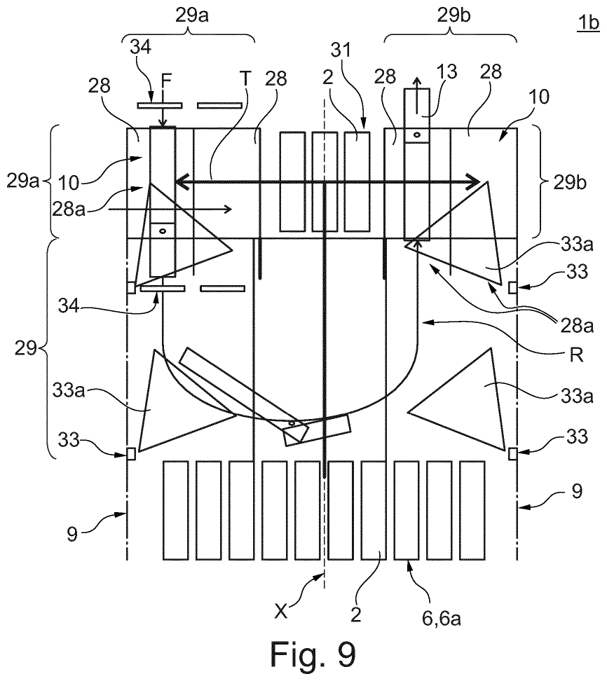

Even without a platform 32 it is possible to ensure that transport vehicles 13 are protected from hazards which can originate from a gantry crane 8 travelling over the intermediate area 29, if the gantry crane is placing a container 2 into storage or removing it from storage. This is apparent from the exemplified embodiment illustrated in FIG. 9.

The entrance area 29a and the exit area 29 and the transfer lanes 28a and transfer locations 28 in each case defined therein correspond to the arrangement of FIG. 8. However, in contrast to FIG. 8, the buffer area 31 is arranged on the ground surface 17 and extends in the direction of the storage area 6a only to such an extent that the routes R are not obstructed thereby. The intermediate area 29 is thus arranged at least partially between the buffer area 31 and the storage area 6a. The transport routes T of the gantry crane 8 likewise correspond to those of FIG. 8 and thus likewise cross the routes R, as seen in the plan view of FIG. 9, only in the intermediate area 29 in the area of the travel with turning movements performed for the change in direction. Since the intermediate area 29 is not covered by a platform 32, a transport vehicle 13 must not be located in the intermediate area 29 to ensure that the gantry crane 8 is allowed to move a container 2 along the longitudinal axis X. This does not include the driver's cab 25 of transport vehicles 13 which stop correctly on the transfer locations 28 because the driver's cab 25 in this case is arranged outside the transfer area 10 and therefore is already located in the intermediate area 29. As long as transport vehicles 13 are located on the route R and in particular during the travel with turning movements underneath the longitudinal axis X or transport route T, the gantry crane 8 must not travel over the intermediate area 29. The gantry crane 8 is then stopped before it travels from the storage area 6a or from the transfer area 10 via the intermediate area 29. Empty journeys of the gantry crane 8 without containers 2 on the load picking-up means can be excluded from this because in this case there is no danger of a load falling.

In order to ensure that the aforementioned boundary conditions for operation of the gantry crane 8 or for transport vehicles 13 entering the intermediate area 29 are met, the intermediate area 29 is monitored by means of sensors 33 to check for the presence of transport vehicles 13. The sensors 33 can be e.g. laser sensors, ultrasonic sensors, radar sensors and/or cameras. The sensors 33 are arranged preferably in the intermediate area 29 such that their respective detection region 33a at least partially detects transport vehicles 13 located in the entrance area 29a and/or in the exit area 29b and/or in the area of the travel with turning movements, and therefore all of the routes R. For example, four sensors 33 can be provided, as illustrated in FIG. 9. If one of the sensors 33 recognizes a transport vehicle 13 located in the intermediate area 29 e.g. during travel with turning movements, the gantry crane 8 can be stopped before it is moved over the intermediate area 29. In this regard, the sensors 33 can also be used to establish whether a transport vehicle 13 has completed the travel in the intermediate area 29 or at least the travel with turning movements underneath the transport route T and the gantry crane 8 can thus be allowed access to the intermediate area 29. The sensors 33 are part of a system for traffic regulation in the previously described sense and in particular in the intermediate area 29 of the store 6.

Alternatively or in addition, the system for traffic regulation can have means for regulating access which can be designed e.g. as a signal device, traffic lights or as a gate 34 serving as a barrier or at least one bollard which can be lowered into the ground. These means can prevent a transport vehicle 13 from entering the entrance area 29 or the intermediate area 29 if each lane of the entrance area 29 is occupied by another transport vehicle 13 or the intermediate area 29 is blocked to ensure that the gantry crane 8 can transport a container 2 over the intermediate area 29. In this regard, corresponding means for access regulation can be arranged e.g. also within the intermediate area 29 a short distance in advance of the area for travel with turning movements or the intersection with the transport route T because the routes R and the transport route T do cross beforehand and a transport vehicle 13 can thus also wait safely within the intermediate area 29 until the gantry crane 8 is no longer located above the intermediate area 29. The means for restricting access can also be connected in terms of control technology to the sensors 33 and can be controlled and activated or deactivated in dependence upon their signals. If no barriers are provided and instead only one signal device is provided, the sensors 33 can also trigger an emergency stop of the gantry crane 8 if the gantry crane 8 is already located above the intermediate area 29 and a transport vehicle 13 ignores stop signals and incorrectly enters the intermediate area 29. For this purpose, the crane controller of the gantry crane 8 is accordingly incorporated into the system for traffic regulation. The vehicle controller 24 can also be incorporated accordingly into the system for traffic regulation, in particular in the case of automatically guided transport vehicles 13 in order to coordinate their movements with those of the gantry crane 8, as previously described.

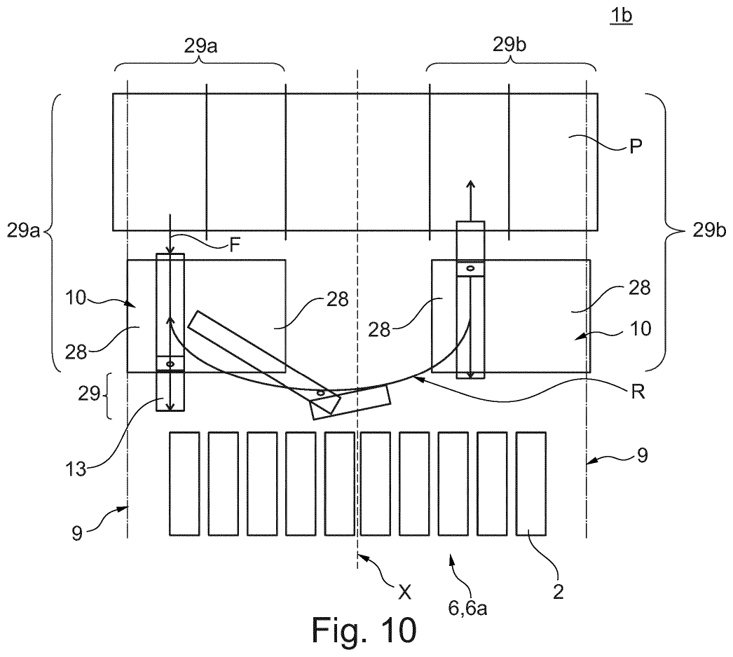

The exemplified embodiment illustrated in FIG. 10 relates to the case that a gantry crane 8 is undergoing maintenance or repair and for this purpose it is moved to one end of the pair of travel paths or rails 9 into an end position P. While the gantry crane 8 is in the end position P, the storage area 6a is managed by a second gantry crane 8 which can be moved on the same travel paths or rails 9. This applies to all exemplified embodiments because generally each storage area 6a is allocated two gantry cranes 8 which can manage the storage area 6a at the same time. If no gantry crane 8 is in the end position P but instead both gantry cranes 8 are involved in regular operation, the two gantry cranes 8 are operated in a coordinated manner such that one gantry crane 8 loads and unloads transport vehicles 13 entering and stopping in the waterside handling area 10 and the other gantry crane 8 loads and unloads transport vehicles 13 entering and stopping in the land-side handling area 11.

If a gantry crane 8 is in the end position P, the transfer area 10 with its transfer locations must be defined or arranged in an offset manner in the direction of the storage area 6a. The transfer area 10 and the associated transfer location 28 can be offset between the end position P of the gantry crane 8 and the intermediate area 29 temporarily only for the duration of the maintenance or repair. By offsetting the transfer area 10, the area available in the intermediate area 29 between the transfer area 10 and the storage area 6a for the travel with turning movements for the purpose of changing direction is reduced at least by the area taken up by the gantry crane 8 in the end position P. On this basis, it may be necessary, as indicated in FIG. 10, that the travel with turning movements must be effected by the transport vehicles 13 partially within the transfer area 10 during the passage there through and moreover rearwards travel must be performed within the transfer area 10 prior to the travel with turning movements as forwards travel. In this case, the travel with turning movements can begin or end within the transfer area 10 and can also run over a plurality of adjacent transfer locations 28 of the respective transfer area 10. However, the rearwards travel can be effected as travel in a straight line so as to permit the U-shaped turning manoeuvre including the passage through the transfer area 10 in the sense in accordance with the invention with a constant wheel drive direction and in particular travelling forwards. This applies irrespective of whether the transfer area 10 is defined in the entrance area 29a and/or in the exit area 29b. If a transfer area 10 is used in the entrance area 29a, rearwards travel is required after stopping at this location and before the forwards travel with turning movements. If a transfer area 10 is used in the exit area 29b, rearwards travel is not required before the travel with turning movements but instead is required after the travel with turning movements and before stopping in the transfer area 10 for correct positioning on the transfer location 28 at that location. The travel in the intermediate area 29 can also be effected, as illustrated in FIG. 10, in an anticlockwise direction or alternatively also in a clockwise direction (not illustrated).

A further exemplified embodiment of the invention is illustrated in FIG. 11. In this case, two adjacent storage areas 6a of the store 6 are operationally combined by connecting the respective intermediate areas 29 such that they form a common intermediate area 29c. The entrance area 29a of the left storage area 6a and the exit area 29b of the right storage area 6a are allocated to the left intermediate area 29, and the entrance area 29a of the right storage area 6a and the exit area 29b of the left storage area 6a are allocated to the right intermediate area 29. Hence, each transport vehicle 13 coming via the entrance area 29a of the left storage area 6a travels along one of the routes R from the left into the right intermediate area 29 and thus via the common intermediate area 29c and subsequently from the right intermediate area 29 into the transfer area 10 of the right storage area 6a and in this case completes a 180° turn in an anticlockwise direction before entering the transfer area 10. In the transfer area 10 of the right storage area 6a which is allocated to the exit area 29 at that location, the transfer of a container 2 by the gantry crane 8 takes place and subsequently the transport vehicle 13 leaves the transfer area 10 or exit area 29b and thus also the area between the travel paths or rails 9. This sequence applies accordingly in reverse in the clockwise direction for the transport vehicles 13 coming via the entrance area 29a of the right storage area 6a. By way of example, in FIG. 11, routes R′ are illustrated for this purpose in broken lines, said routes leading to the transfer locations 28 of the left storage area 6a which are defined likewise in the exit area 29b.

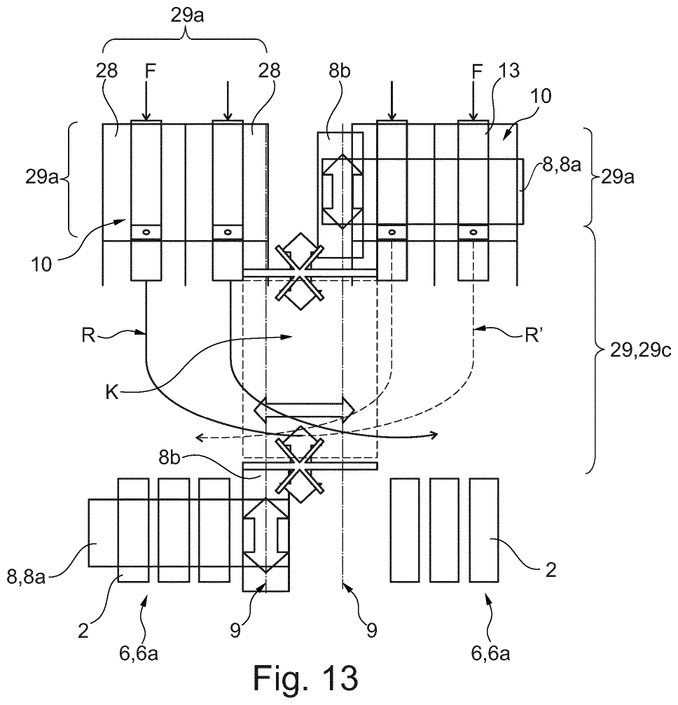

The respective routes R and R′ or the transport vehicles 13 travelling along these routes R, R′ through the intermediate areas 29 of the common intermediate area 29c thus cross the travel path—including the rails 9—of the gantry cranes 8 of the two adjacent storage areas 6a in a crossing area K. In particular, the crossing area K is where the transport vehicles 13 can encounter one another in oncoming traffic on the routes R and R′ to be departed from in opposite directions. In order to avoid collisions here, at least two separate lanes can be provided, of which in each case one is designated for the route R and one is designated for the route R′. Alternatively, the above-described system for traffic regulation can also be used to coordinate alternating travel of transport vehicles 13 on the routes R and R′ in the common intermediate area 29c and so collisions caused by oncoming traffic can be avoided in particular in the crossing area K. In this case, the journeys of the transport vehicles 13 can also be coordinated with the journeys of the gantry crane 8 through the crossing area K and so the gantry crane 8 is permitted access to operate in this crossing area, wherein during this time no transport vehicle 13 is allowed to be located in the crossing area K and transport vehicles 13 are prevented from entering the crossing area K. Alternatively, as illustrated in FIG. 13 by corresponding and partially struck-through double arrows, the coordinating procedure can be performed in such a manner that a transport vehicle 13 is allowed to pass through the crossing area K, wherein during this time no gantry crane 8 is allowed to be located in the crossing area K and gantry cranes 8 are prevented from entering the crossing area K. For this purpose, the crane controllers or vehicle controllers 24 can be incorporated into the system for traffic regulation in order to avoid collisions between transport vehicles 13 and gantry cranes 8, in particular their running gear unit supports 8b (see FIG. 13). By means of the system for traffic regulation, it is also possible in a computer-based manner for positions of the transport vehicles 13 and gantry cranes 8 as well as permissions to access the crossing area K, the intermediate areas 29, 29c and entrance areas 29a to processed or managed and in this regard for the corresponding sensors 33 and means for restricting access to be controlled. For this purpose, the transport vehicles 13 and gantry cranes 8 themselves can also be provided with sensors in terms of the aforementioned sensors 33 and therefore safety can be increased further by such redundancy and processing of the corresponding sensor signals in the system for traffic regulation.

Each of the two adjacent storage areas 6a has a transfer area 10, through which a vehicle can pass in the manner already described and which has at least one transfer location 28. In FIG. 11, the transfer areas 10 or their transfer locations 28 are each allocated to one of the two exit areas 29b and are designed having multiple lanes, namely five lanes, and therefore correspondingly many transfer locations 28 are present in the lanes of the exit areas 29b serving as transfer lanes 28a. The entrance areas 29a are each designed having a single lane but can also have multiple lanes and therefore correspondingly fewer transfer lanes 28a and transfer locations 28 are present. In this case, the single-lane entrance areas 29a are arranged on the left or right edge of the respective storage area 6a but can also be arranged between two transfer locations 28 or transfer lanes 28a of a storage area 6a and so the transfer area 10 is divided by the entrance area 29a. Also, in contrast to FIG. 11, single or multiple transfer locations 28 can be used as a buffer area in terms of the previously described buffer areas 31.

The exemplified embodiment illustrated in FIG. 12 represents a modification of the exemplified embodiment of FIG. 11. The transfer areas 10 and their transfer lanes 28a or transfer locations 28 are arranged at the same point but vehicles pass there through in the reverse direction compared to FIG. 11. Accordingly, the transfer areas 10 are each part of the entrance area 29a and so the U-shaped turns effected along the routes R or R′ are each effected after passage through the transfer area 10. In this case, the single-lane exit areas 29b are arranged on the left or right edge of the respective storage area 6a but can also be arranged between two transfer locations 28 or transfer lanes 28a of a storage area 6a and so the transfer area 10 is divided by the exit area 29b. In the same way that the entrance area 29a in FIG. 11 can have multiple lanes, this is also possible for the exit area 29b in FIG. 12. The adjacent storage areas 6a are in each case mirror-symmetrical with respect to one another in FIGS. 11 and 12.

Of course, other vehicle types, such as e.g. container transport vehicles comprising a loading surface 23, which is provided on the towing vehicle itself and is rigid or can be lifted/lowered, and guide elements 23a can also be used as internal transport vehicles 13, which would permit simpler rearwards travel by reason of the vehicle symmetry and the lack of drawbar or lack of trailer connected in an articulated manner However, even in the case of these transport vehicles 13, a change in the wheel drive direction when travelling in the transfer area 10 can be avoided by reason of the present invention.

During the transfer of containers 2 to the gantry crane 3, the orientation of the container door is generally taken into consideration to ensure that all of the containers 2 are placed into the store 6 with the same orientation of the container door, e.g. pointing in the direction of the land-side handling area 1c. In order to deliver the containers 2 in the transfer area 10 with the desired orientation of the container door, the containers 2 are to be loaded with corresponding orientation onto the transport vehicles 13 with knowledge of the allocation of the transfer area 10 to the entrance area 29a or exit area 29b. If e.g. the container doors of the containers 2 placed into storage are to point in the direction of the land-side handling area 1c and a container 2 has been loaded onto the transport vehicle 13 with an orientation of the container door pointing in the direction of the rear of the transport vehicle 13, during forwards travel it is only possible to approach storage areas 6a in which the transfer area 10 is defined in the exit area 6b (see e.g. FIGS. 4, 5 and 11). However, if a storage area 6a, whose transfer area 10 is defined in the entrance area 29a (see e.g. FIGS. 6, 7 and 12), is to be approached during forwards travel, the container 2 must be positioned in a correspondingly different manner on the transport vehicle 13. If in each case at least one transfer area 10 or transfer location is provided in the entrance area 29a and in the exit area 29b of a storage area 6a (see e.g. FIGS. 8, 9 and 10), it is possible, depending upon the orientation of the container door on the transport vehicle 13, to use the one transfer location of the two transfer locations which ensures that the container is placed into storage with the correct orientation of the container door. In this case, the containers 2 can thus be loaded onto the transport vehicle 13 with any orientation of the container door. Otherwise, in the case of a plurality of storage areas 6a including transfer locations 28 arranged in a correspondingly different manner in the entrance area 29a or exit area 29b, it is possible to approach only the storage area 6a which is suitable accordingly for the correct orientation of the container door.

In principle, the store 6 can also have combinations of the previously described exemplified embodiments and accordingly can have in particular different arrangements or allocations of the entrance areas 29a, exit areas 29b, intermediate areas 29, 29c as well as transfer areas 10 in relation to the respective storage areas 6a. The same applies to the land-side area of the store 6 and the second transfer areas 11 at that location which are designed analogously to the above-described first transfer areas 10 and can be arranged so as to be separated from the respective storage areas 6a by means of a corresponding intermediate area 29 or common intermediate area 29c. Therefore, for the external transport vehicles 7 travelling on the land-side, corresponding methods for the operation thereof are likewise possible with regard to the land-side placement of containers 2 into the store 6 or the land-side removal of said containers therefrom.

1. A store for containers that has at least one storage area and one gantry crane, wherein the storage area is arranged between two travel paths for the gantry crane such that the gantry crane can be moved over the storage area on the travel paths, and wherein a transfer area is arranged at an end of the storage area pointing in the travel direction of the gantry crane between the travel paths, with the transfer area being able to be reached by the gantry crane and by a transport vehicle for containers in order to place containers into the store or to remove the containers from the store, and wherein an intermediate area is provided between the transfer area and the storage area, wherein the transfer area and the intermediate area are designed and arranged such that a transport vehicle is able to pass through the transfer area and travel in the intermediate area, and wherein the travel in the intermediate area is possible before or after passing through the transfer area.

2. The store as claimed in claim 1, wherein an entrance area is provided between the travel paths of the gantry crane, through which a transport vehicle can approach the intermediate area, and/or an exit area is provided between the travel paths of the gantry crane, through which a transport vehicle can move away from the intermediate area, and wherein the transfer area is allocated to the entrance area or to the exit area.

3. The store as claimed in claim 2, wherein two transfer areas are provided, of which a first transfer area is allocated to the entrance area and a second transfer area is allocated to the exit area.

4. The store as claimed in claim 1, wherein the intermediate area is configured such that for a transport vehicle, travel with turning movements is possible in the intermediate area by a 90° degree turn and/or a 180° degree turn along a U-shaped route.

5. A store for containers that has two adjacent storage areas and two gantry cranes, wherein the storage areas are arranged in each case between two travel paths for one of the gantry cranes such that the respective gantry crane can be moved over the respective storage area on the travel paths, and wherein in each case a transfer area is arranged at an end of the respective storage area pointing in the travel direction of the gantry crane between the travel paths with the transfer area being able to be reached by the respective gantry crane and by a transport vehicle for containers in order to place containers into the store or to remove the containers from the store, and wherein an intermediate area is provided in each case between the transfer area and the storage area, wherein the transfer area and the intermediate area are designed and arranged such that a transport vehicle is able to pass through the transfer area and travel in the intermediate area, and wherein the travel in the intermediate area is possible before or after passing through the transfer area.

6. A store as claimed in claim 5, wherein an entrance area is provided in each case between the travel paths of the respective gantry cranes through which a transport vehicle can approach the intermediate area, and/or an exit area is provided between the travel paths of the gantry crane through which a transport vehicle can move away from the intermediate area, and wherein the respective transfer area is allocated to the entrance area or to the exit area.

7. The store as claimed in claim 5, wherein the intermediate areas are connected to one another such that they form a common intermediate area.

8. The store as claimed in claim 6, wherein the entrance area has a single lane and the exit area has multiple lanes, or the entrance area has multiple lanes and the exit area has a single lane, or the entrance area and the exit area each have multiple lanes.

9. The store as claimed in claim 5, wherein a system for traffic regulation is provided.

10. The store as claimed in claim 5, wherein a buffer area is arranged between the travel paths for each gantry crane such that in each case the intermediate area is arranged between the buffer area and the storage area.

11. (canceled)

12. A method for operating at least one transport vehicle for containers in a store, wherein the store has at least one storage area and one gantry crane, wherein the storage area is arranged between two travel paths for the gantry crane such that the gantry crane can be moved over the storage area on the travel paths, and wherein a transfer area is arranged at an end of the storage area pointing in the travel direction of the gantry crane between the travel paths, with the transfer area being able to be reached by the gantry crane and by a transport vehicle for containers in order to place containers into the store or to remove the containers from the store, and wherein an intermediate area is provided between the transfer area and the storage area, said method comprising:
traveling by the transport vehicle in the intermediate area; and
passing through the transfer area with the transport vehicle either before or after said traveling by the transport vehicle in the intermediate area.

13. The method as claimed in claim 12, wherein said traveling by the transport vehicle in the intermediate area comprises turning movements, and wherein said turning movements comprises a 90° degree turn and/or a 180° degree turn along a U-shaped route.

14. The method as claimed in claim 12, wherein said traveling by the transport vehicle comprises traveling in a common intermediate area of two adjacent storage areas with turning movements, and wherein said turning movements comprises a 90° degree turn and/or a 180° degree turn along a U-shaped route.

15. The method as claimed in claim 12, wherein the transport vehicle crosses one of the travel paths of the gantry crane.

16. The method as claimed in claim 12, wherein the traffic in the store is regulated.

17. The method as claimed in claim 12, wherein the transport vehicle comprises a trailer truck.

18. The method as claimed in claim 12, wherein the storage area comprises two adjacent storage areas and two gantry cranes, wherein the storage areas are arranged in each case between two travel paths for one of the gantry cranes such that the respective gantry crane can be moved over the respective storage area on the travel paths, and wherein in each case a transfer area is arranged at an end of the respective storage area pointing in the travel direction of the gantry crane between the travel paths with the transfer area being able to be reached by the respective gantry crane and by a transport vehicle for containers in order to place containers into the store or to remove the containers from the store, and wherein an intermediate area is provided in each case between the transfer area and the storage area.

19. The store as claimed in claim 1, wherein a platform is arranged above the intermediate area.

20. The store as claimed in claim 2, wherein the entrance area has a single lane and the exit area has multiple lanes, or the entrance area has multiple lanes and the exit area has a single lane, or the entrance area and the exit area each have multiple lanes.

21. The store as claimed in claim 1, wherein a buffer area is arranged between the travel paths for each gantry crane such that in each case the intermediate area is arranged between the buffer area and the storage area.
